(19) United States
(12) Patent Application Publication
(10) Pub. No.: US 2025/0041941 A1
(43) Pub. Date: Feb. 6, 2025

(54) SYSTEM AND METHOD FOR ADAPTIVE FLOW REGULATION OF MOLTEN METAL IN A TILTING MELTING HEARTH ATOMIZATION SYSTEM

(71) Applicant: CONTINUUM POWDERS CORPORATION, Cloverdale, CA (US)

(72) Inventors: PAUL MEESE, HEALDSBURG, CA (US); JEFF McINTIRE, Castro Valley, CA (US); MATTHEW CHARLES, Cloverdale, CA (US); EMMANUEL MOTA, Healdsburg, CA (US)

(73) Assignee: Continuum Powders Corporation, Cloverdale, CA (US)

(21) Appl. No.: 18/926,463

(22) Filed: Oct. 25, 2024

Related U.S. Application Data
(63) Continuation-in-part of application No. 17/976,755, filed on Oct. 29, 2022, now Pat. No. 12,145,197.
(60) Provisional application No. 63/273,291, filed on Oct. 29, 2021.

(51) Int. Cl. B22F 9/08

(52) U.S. Cl. CPC B22F 9/082; B22F 2009/0888; B22F 2203/03

(57) ABSTRACT

An adaptive flow regulation system for a tilting melting hearth atomization system includes: a load cell sensor configured to capture a weight of a molten metal within a tilting melting hearth during a pouring operation; a process camera configured to capture visual characteristics of the molten metal during the pouring operation; a particle size analyzer configured to analyze a metal powder following an atomization process to determine a particle size distribution of the metal particles; an actuator coupled to a linkage configured to support and move the tilting melting hearth to a desired hearth tilt angle; and a central processing unit (CPU) having a machine learning program configured to receive data from the load cell sensor, the process camera, and the particle size analyzer and to send a control signal to the actuator for controlling a pour rate from a melting cavity of the tilting melting hearth.

### CROSS REFERENCE TO RELATED APPLICATION

This application is a continuation-in-part of Ser. No. 17/976,755, filed Oct. 29, 2022, which claims priority from U.S. Provisional No. 63/273,291, filed Oct. 29, 2021, both of which are incorporated herein by reference.

### FIELD

This disclosure relates to a system and method for regulating the flow of molten metal in a tilting melting hearth atomization system.

### BACKGROUND

There is a need in the industry for greater process control in a tilting melting hearth atomization system, specifically one where the deposition of liquid metal in a gas stream or fixed container are repeatable, and precision amounts are crucial to the process parameters.

The current state of the art with DPA (Direct Pour Atomization) production requires an amount of molten material to be poured through a calibrated pour notch creating a uniform pour stream into a preferred location in an atomization gas stream, or into a small induction crucible for near net shape, void-free castings. In some systems, the physical window of either target has an approximate diameter of about 0.875″ and a preferred diameter of the pour stream of molten metal of about 0.375″. Any pouring outside of this window can lead to an ineffective process, a clogged gas die, or a plugged induction mold or crucible. Any variation in the pour stream diameter itself as it interacts with a stable gas stream can lead to variability in a gas to metal ratio, which in turn leads to poor atomization performance.

One additional consideration is that while processing scrap material as feedstock, the variable shape and weight per charge loaded into the hearth can cause differences in the operational parameters preventing formation of a precision pour stream. This in turn leads to variability in processing of the above metals. Those skilled in the art of gas atomization understand that a specific gas-to-metal ratio by weight is desirable and variations from that will create inefficiencies in production yield.

U.S. Pat. Nos. 9,925,591 and 10,654,106, which are incorporated herein by reference, disclose an exemplary metallurgical system that includes a tilting melting hearth system. In this tilting melting hearth system, current operation standards call for the operator to make a judgment based on visual input from the process cameras to determine the fluid level in the tilting melting hearth prior to every pour. The operator must visually judge whether or not the fluid level is correct for the process, and when to start the atomization gas stream that intersects with the molten pour stream. This operator judgment is made up to 20 times per heat. The fluid level has a narrow window of operational parameters where a lesser amount can result in a lack of fluid pressure leading to a short and unstable pouring event. Conversely, an overfill of the hearth can cause a dribble of molten material to build up on the gas die leading to a premature shut down of the atomization or ingot making process. Narrowing the parameters even more are processes in which alloys are being created in the melting hearth via magnetic stirring where melt cycles are defined by energy input per weight of material and a characterized vaporization rate of materials is determined.

The present disclosure is directed to a system and method for regulating the flow of molten metal in a tilting melting hearth atomization system.

### SUMMARY

A tilting melting hearth atomization system includes a tilting melting hearth having a melting cavity configured to melt a metal into a molten metal, and a pour notch configured to pour the molten metal from the melting cavity. The tilting melting hearth atomization system also includes an atomization system configured to receive a stream of the molten metal from the pour notch and perform an atomization process to form a metal powder comprised of metal particles.

An adaptive flow regulation system for the tilting melting hearth atomization system includes: a load cell sensor configured to capture a weight of the molten metal within the melting cavity during a pouring operation; a process camera configured to capture visual characteristics of the molten metal during the pouring operation; a particle size analyzer positioned downstream or proximate to the atomization system configured to analyze the metal powder following the atomization process to determine a particle size distribution of the metal particles; an actuator coupled to a linkage configured to support and move the tilting melting hearth to a desired hearth tilt angle; and a central processing unit (CPU) operably associated with a machine learning program configured to receive data from the load cell sensor, the process camera, and the particle size analyzer and to send a control signal to the actuator for controlling the hearth tilt angle of the tilting melting hearth and a pour rate from the melting cavity. The data can be received in real time and can be stored in time series or other format by the central processing unit (CPU) allowing the machine learning program to control the pouring and atomization processes.

A method for adaptive flow regulation of molten metal in a tilting melting hearth atomization system includes the steps of: capturing a weight of the molten metal within a tilting melting hearth during a pouring operation using a load cell sensor; capturing visual characteristics of the molten metal during the pouring operation using a process camera; and analyzing a particle size distribution of the metal powder following the atomization process using a particle size analyzer. The method also includes the steps of providing an actuator coupled to a linkage configured to support and move the tilting melting hearth to a desired hearth tilt angle, and providing a central processing unit (CPU) having a machine learning program configured to receive data from the load cell sensor, the process camera, and the particle size analyzer and to send a control signal to the actuator for controlling the hearth tilt angle of the tilting melting hearth and a pour rate from the melting cavity. The method also includes the step of controlling the hearth tilt angle of the tilting melting hearth and the pour rate from the melting cavity using the central processing unit (CPU), the load cell sensor, the process camera, the particle size analyzer and the actuator.

### BRIEF DESCRIPTION OF THE DRAWINGS

FIG. 1 is a schematic diagram of a tilting melting hearth atomization system having an adaptive flow regulation system;

FIG. 2 is a schematic diagram of an atomization system of the tilting melting hearth atomization system;

FIG. 3A is a perspective view of a metal powder fabricated using the tilting melting hearth atomization system;

FIG. 3B is an enlarged schematic cross-sectional view of a single metal particle of the metal powder; and

FIG. 4 is a perspective view illustrating different hearth tilt angles for a tilting melting hearth of the tilting melting hearth atomization system.

### DETAILED DESCRIPTION

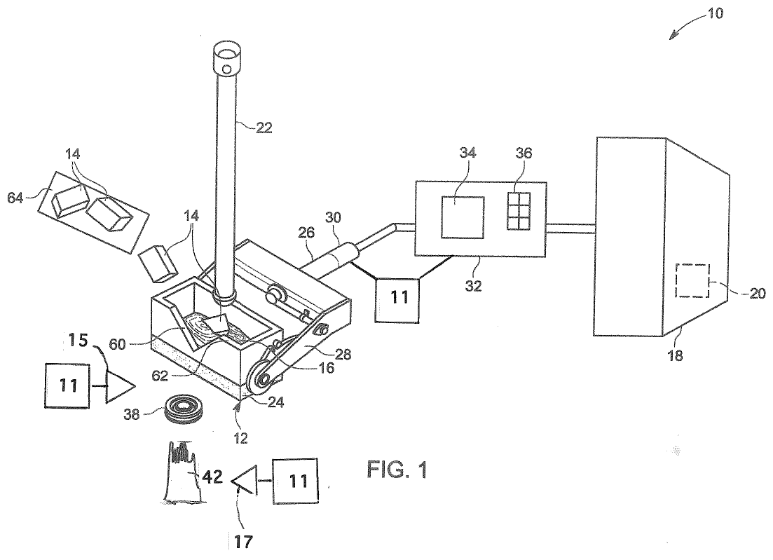

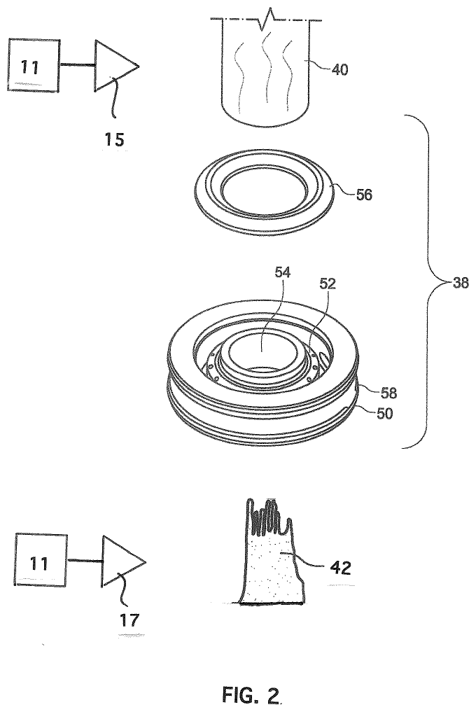

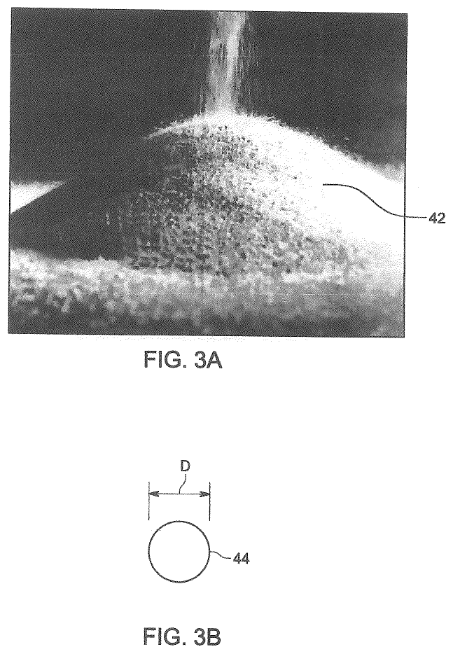

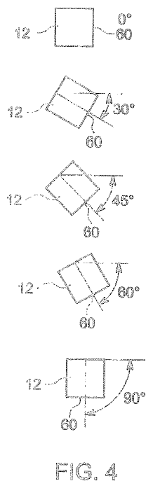

Referring to FIG. 1, a tilting melting hearth atomization system 10 includes a tilting melting hearth 12 having a melting cavity 62 configured to melt a metal 14 into a molten metal 16 and a pour notch 60 configured to pour the molten metal 16 from the melting cavity 62. The tilting melting hearth atomization system 10 also includes an atomization system 38 configured to receive a stream of the molten metal 40 (FIG. 2) from the pour notch 60 and perform an atomization process to form a metal powder 42 comprised of metal particles 44 (FIG. 3B).

The metal 14 can comprise any feedstock, including but not limited to: bars, blocks, rounds, chunks, powders, flakes, pellets or any size or shape that can be fed into a vessel. By way of example, recycled scrap metals can include reactive metals such as titanium, zirconium, nickel, cobalt and alloys thereof. As another example, recycled scrap metals can include nonreactive metals, such as steel, iron and alloys thereof. In an exemplary embodiment, scrap metals can be collected from a battlefield near a forward operating base. In another embodiment, parts can be recycled on board an aircraft carrier, oil rig, or some other remote facility. Preferably, large pieces of scrap metal are collected, analyzed by handheld XRF, and cut to pieces smaller than 6″ in diameter. Smaller fragments of scrap metals are preferably not collected due to lower yield, greater variations in alloy composition, and increased likelihood of contamination.

A feeder 64, such as a tube, channel, or conveyor, in close proximity to the tilting melting hearth 12, feeds the metal 14 into the melting cavity 62. The tiling melting hearth 12 also includes an induction coil 24 configured to heat the molten metal 16 in the melting cavity 62. In addition, the tilting melting hearth atomization system 10 includes an external heat source 22, such as a plasma torch system, a plasma transferred arc system, an electric arc system, an induction system, a photon system, or an electron beam energy system in close proximity to the melting cavity 62 of the tilting melting hearth 12, which is also configured to heat the molten metal 16. U.S. Pat. Nos. 9,925,591 and 10,654,106, both of which are incorporated herein by reference, describe further details of the tilting melting hearth 12, including electromagnetic stirring.

As shown in FIG. 5, the tilting melting hearth 12 can be tilted at different hearth tilt angles from 0 to 90 degrees, measured from a horizontal placement of the tilting melting hearth 12 to pour the molten metal 16 through the pour notch 60 into the atomization system 38 with a uniform stream of molten metal 40 and a uniform pour rate.

As shown in FIG. 2A, the atomization system 38 includes a metal body 50 having passageways for inert gas jets 52. The atomization system 38 also includes an orifice 54 in the center, a cover 56, and a gas inlet 58. The inert gas jets 52, which are arranged in a circular pattern, impinge inert gas onto the stream of molten metal 40. The inert gas jets 52 all converge on the stream of molten metal 40 to disintegrate the stream of molten metal 40 and generate the metal powder 42 (FIG. 3A) forming the particles 44 (FIG. 3B) with a desired shape (e.g., spherical) and particle size (e.g., diameter D of 1-500 μm) and particle size distribution depending on the application. The particles 44 (FIG. 3B) cool in free-fall until reaching the bottom of an atomization tower (not shown). The metal powder 42 (FIG. 3A) is segregated into groups of similar particle size using gravity, screening, or cyclonic separation.

As shown in FIG. 1, the tilting melting hearth atomization system 10 also includes an adaptive flow regulation system 11 configured for adaptive flow regulation of molten metal 16 from the tilting melting hearth 12. The adaptive flow regulation system 11 includes a load cell sensor 30 configured to capture a weight of the molten metal 16 within the melting cavity 62 during a pouring operation. The adaptive flow regulation system 11 also includes a process camera 15 configured to capture visual characteristics of the molten metal 16 during the pouring operation.

Still referring to FIG. 1, the adaptive flow regulation system 11 also includes a particle size analyzer 17 configured to analyze the metal powder 42 following the atomization process to determine a particle size and a particle size distribution of the metal particles 44 (FIG. 3). The particle size analyzer 17 can comprise a commercial instrument that employs known technologies, such as laser diffraction or dynamic light scattering. Exemplary commercial instruments include the MASTERSIZER series of instruments manufactured by Malvern Panalytical of Westborough MA. For example, the MASTERSIZER 3000+ uses laser diffraction to measure a particle size, and particle size distribution of metal powders. The analyzing step is performed following completion of the atomizing process but prior to the collection process. In FIG. 3A, the analyzing step would preferably be performed on the moving airborne particles 44 of the metal powder 42 shown as the moving particle stream at 12 o'clock before the collection pile in middle of the drawing forms. This location is termed herein “downstream” or “proximate” to the atomization system 38 but following the atomization process.

The adaptive flow regulation system 11 also includes an actuator 26 coupled to a linkage 28 configured to support and move the tilting melting hearth 12 to a desired hearth tilt angle. The actuator 26 can also include an encoder (not shown) configured to transmit positional data. The adaptive flow regulation system 11 also includes a central processing unit (CPU) 18 configured to receive data from the load cell sensor 30, the process camera 15, and the particle size analyzer 17 and to send a control signal to the actuator 26 for controlling the hearth tilt angle of the tilting melting hearth 12 and a pour rate from the melting cavity 62. The central processing unit (CPU) 18 also includes a digital readout 32 having a display screen 34 configured to display information and a keypad 36 configured to input information to the central processing unit (CPU) 18. For example, the input information can include a profile of mechanical properties of the molten metal 40 (FIG. 2A) and a desired flow rate of the pour stream of molten metal 40 (FIG. 2A).

The central processing unit (CPU) 18 also includes a machine learning program 20 having a model configured to tie the data together and control the pouring and atomization processes. For example, the machine learning program 20 can include a regression-based model trained on a dataset comprising time-series data of:
A. Stream width and temperature of the pour stream of molten metal 40 (FIG. 2A), weight of the molten metal 16 (FIG. 1) within the tilting melting hearth 12 (FIG. 1), angle of the actuator 26 (FIG. 1) coupled to the linkage 28 (FIG. 1) connected to the tilting melting hearth 12 (FIG. 1).
B. Particle size distribution of atomized particles 44 (FIG. 3B) of the metal powder 42 (FIG. 3A) prior to collection bin egress.
C. The process can be controlled to incorporate desired flow rate, ideal particle size distribution, and the fixed mechanical properties of the molten metal 40 (FIG. 2A), including but not limited to viscosity, surface tension, and density, as input parameters, wherein the machine learning program 20 (FIG. 1) dynamically adjusts the pouring process based on these properties and the time-series data to optimize material yield and product quality.
D. The machine learning program 20 includes a model configured for training using a supervised learning method, and the model receives feedback on an accuracy of predictions of the molten metal pour rate relative to pour rate input parameters.
E. The machine learning program is configured for maximizing yield in desired particle size distribution ranges defined within input parameters.

All of the data can be received in real time and can be stored in time series by the central processing unit (CPU) 18. This data can then be used by the machine learning program 20 to control the pouring and atomization processes.

Exemplary data can include:
1. Hearth weight captured by load cell sensor 30 (FIG. 1), with the weight data received in real time and stored in time series by the central processing unit (CPU) 18.
2. Pour stream size of molten metal 40 (FIG. 2A) captured by camera including a pour stream width, with the pour stream data received in real time and stored as image frames by the central processing unit (CPU) 18.
3. Particle size characteristics captured by the particle size analyzer 17 (FIG. 1) stored as time series particle size distribution data by the central processing unit (CPU) 18.
4. The position of the actuator 26 (FIG. 1) is received by the central processing unit (CPU) 18 and processed and stored as hearth tilt angle (FIG. 5) in time series.
5. The visual characteristics of the pour stream of molten metal 40 (FIG. 2A) are converted to a pour width and a pour temperature. For example, an edge detection algorithm can be used to calculate the width of the pour stream, and an optical pyrometry algorithm can be used to determine the temperature of the pour stream, which can be further stored as time series data.
6. The mechanical properties of the metal 14 (FIG. 1) being poured are entered as input parameters.
7. A temperature and a pour stream width of the pour stream of the molten metal 40 (FIG. 2A) are used to calculate a flow rate and are stored as time series data by the central processing unit (CPU) 18.
8. The machine learning program 20 (FIG. 1) ties the data together and adjusts the pour rate into the atomization system 38.

While a number of exemplary aspects and embodiment have been discussed above, those of skill in the art will recognize certain modification, permutations, addition, and sub-combinations thereof. It is therefore intended that the following appended claims and claims hereafter introduced are interpreted to include all such modifications, permutations, additions, and sub-combinations as are within their true spirit and scope.

What is claimed:

1. An adaptive flow regulation system for a tilting melting hearth atomization system comprising:
a load cell sensor configured to capture a weight of a molten metal within a tilting melting hearth of tilting melting hearth atomization system during a pouring operation;
a process camera configured to capture visual characteristics of the molten metal during the pouring operation;
a particle size analyzer positioned proximate to an atomization system of the tilting melting hearth atomization system configured to analyze a metal powder produced by the atomization system following an atomization process to determine a particle size distribution of the metal powder;
an actuator coupled to a linkage configured to support and move the tilting melting hearth to a desired hearth tilt angle; and
a central processing unit (CPU) operably having a machine learning program configured to receive data from the load cell sensor, the process camera, and the particle size analyzer and to send a control signal to the actuator for controlling a pour rate from the tilting melting hearth.

2. The adaptive flow regulation system of claim 1 wherein the data includes material weight data captured by the load cell sensor and configured for processing by the central processing unit (CPU) in real time and for storing as time-series data.

3. The adaptive flow regulation system of claim 1 wherein the data includes visual characteristics of each tilting melting hearth pour captured by the process camera and configured for processing by the central processing unit (CPU) in real time as image frames for storing as video data.

4. The adaptive flow regulation system of claim 1 wherein the data includes particle quality data captured by the particle size analyzer and configured for processing by the central processing unit (CPU) in real time for storing as time series data.

5. The adaptive flow regulation system of claim 1 wherein the data includes positional data of the actuator configured for processing by the central processing unit as an angle of the tilting melting hearth in real time for storing as time series data.

6. The adaptive flow regulation system of claim 1 wherein the data includes visual characteristics of a molten metal pour stream configured for processing by the central processing unit (CPU) and for processing in real time using an edge detection algorithm to calculate a width of the molten metal pour stream, and using a pixel intensity delta algorithm to determine a temperature of the molten metal pour stream.

7. The adaptive flow regulation system of claim 1 wherein a profile comprising one or more mechanical properties of the molten metal and a desired flow rate of a molten metal pour stream serve as input parameters to the central processing unit (CPU).

8. The adaptive flow regulation system of claim 1 wherein a molten metal pour stream width, temperature and mechanical material properties data are used to calculate a flow rate of the molten metal pour stream in real time and for further storing as time series data.

9. The adaptive flow regulation system of claim 1 wherein the machine learning program comprises a regression-based model trained on a dataset comprising time-series data of a stream width and temperature of the molten metal, a weight of the molten metal within the tilting melting hearth, and particle size distribution of the metal powder.

10. The adaptive flow regulation system of claim 1 wherein the machine learning program incorporates a plurality of properties including a desired flow rate, an ideal particle size distribution, and fixed mechanical properties of the molten metal, as input parameters, and wherein the machine learning program is configured to dynamically adjust the pouring process based on the properties and the data to optimize material yield and product quality.

11. The adaptive flow regulation system of claim 1 wherein the machine learning model outputs continuous position control signals through the central processing unit (CPU) to the actuator to derive a tilt angle and rate of change.

12. The adaptive flow regulation system of claim 1 wherein the machine learning program includes a model configured for training using a supervised learning method, wherein the model receives feedback on an accuracy of predictions of the molten metal pour rate relative to pour rate input parameters.

13. The adaptive flow regulation system of claim 1 wherein the machine learning program is configured for maximizing yield in desired particle size distribution ranges defined within input parameters.

14. A method for adaptive flow regulation of a molten metal in a tilting melting hearth atomization system having a tilting melting hearth comprising:
capturing a weight of the molten metal within the tilting melting hearth during a pouring operation using a load cell sensor;
capturing visual characteristics of the molten metal during the pouring operation using a process camera;
analyzing a particle size distribution of the metal powder following an atomization process performed by the tilting melting hearth atomization system using a particle size analyzer;
providing an actuator coupled to a linkage configured to support and move the tilting melting hearth to a desired hearth tilt angle;
providing a central processing unit (CPU) having a machine learning program configured to receive data from the load cell sensor, the process camera, and the particle size analyzer and to send a control signal to the actuator for controlling a hearth tilt angle of the tilting melting hearth and a pour rate from the tilting melting hearth; and
controlling the hearth tilt angle of the tilting melting hearth and the pour rate from the melting hearth using the central processing unit (CPU), the load cell sensor, the process camera, the particle size analyzer and the actuator.

15. The method of claim 14 wherein the data includes material weight data captured by the load cell sensor and configured for processing by the central processing unit (CPU) in real time and for storing as time-series data.

16. The method of claim 14 wherein the data includes visual characteristics of each tilting melting hearth pour captured by the process camera and configured for processing by the central processing unit (CPU) in real time as image frames and for storing as video data.

17. The method of claim 14 wherein the data includes particle quality data captured by the particle size analyzer and configured for processing by the central processing unit (CPU) in real time for storing as time series data.

18. The method of claim 14 wherein the data includes positional data of the actuator configured for processing by the central processing unit as an angle of the tilting melting hearth in real time for storing as time series data.

19. The method of claim 14 wherein the data includes visual characteristics of a molten metal pour stream configured for processing by the central processing unit (CPU) and for processing in real time using an edge detection algorithm to calculate a width of the molten metal pour stream, and using an optical pyrometry algorithm to determine a temperature of the molten metal pour stream.

20. The method of claim 14 wherein the machine learning program incorporates a plurality of properties including a desired flow rate, an ideal particle size distribution, and fixed mechanical properties of the molten metal, as input parameters, and wherein the machine learning program is configured to dynamically adjust the pouring process based on the properties and the data to optimize material yield and product quality.
